(19) United States
(12) Patent Application Publication
(10) Pub. No.: US 2003/0158636 A1
(43) Pub. Date: Aug. 21, 2003

(54) Method and device for detecting dangerous driving maneuvers

(76) Inventor: Hardy Haas, Ditzingen-Schoeckingen (DE)

Correspondence Address: KENYON & KENYON, ONE BROADWAY, NEW YORK, NY, 10004, US

(21) Appl. No.: 10/339,446

(22) Filed: Jan. 9, 2003

(30) Foreign Application Priority Data
Jan. 12, 2002 (DE) 102 00 950.3

(51) Int. Cl. G06F 17/00

(52) U.S. Cl. 701/1; 340/440

(57) ABSTRACT

A method and a device for detecting critical driving conditions of a vehicle are provided, in which instantaneous values of a variable describing the transverse dynamics are measured, and a critical driving condition is detected by evaluating the time characteristic of the ascertained values. In order to detect a critical driving condition, a determination is made as to whether the ascertained values exceed an upper limiting value and, subsequently, fall below a lower limiting value, or whether the ascertained values fall below a lower limiting value and, subsequently, exceed an upper limiting value. Furthermore, a determination is also made as to whether the time interval between a first time point associated with the exceeding of the upper limiting value and a second time point associated with the falling below of the lower limiting value does not meet a specifiable time threshold value.

### FIELD OF THE INVENTION

The present invention relates to a device and a method for detecting critical driving conditions.

### BACKGROUND INFORMATION

German Published Patent Document No. 198 44 912 relates to a device for influencing the propulsion of a vehicle. For this purpose, the device has a first means, which measures a transverse acceleration variable describing the transverse acceleration acting upon the vehicle. In addition, the device has a second means, which determines a quantity describing the time characteristic of the transverse acceleration variable. The device also has a third means, which determines an intervention quantity at least as a function of the transverse acceleration variable and of the variable describing the time characteristic of the transverse acceleration variable. In addition, the device has a fourth means, which performs at least engine interventions to influence the propulsion, the engine interventions being undertaken as a function of the intervention quantity.

### SUMMARY OF THE INVENTION

In the method according to the present invention, instantaneous values of a quantity describing the transverse dynamics are determined at specific time points, and a critical driving condition is detected by evaluating the time characteristic of the ascertained values.

In accordance with the present invention, detecting a critical driving condition involves: a determination is made as to whether the measured values exceed an upper threshold value and subsequently fall below a lower threshold value, or whether the measured values fall below a lower threshold value and then exceed an upper threshold value; and a determination is made as to whether the time interval between a first time point associated with the exceeding of the upper threshold value and a second time point associated with the falling below the lower threshold value does not attain a specifiable time threshold value.

For illustrative purposes, this signifies the following: from all the time points associated with the exceeding of the upper limiting value, a first time point is selected. This may be, for example, the time point at which the upper limiting value is exceeded. However, it may also be the time point at which the variable describing the transverse dynamics reaches a maximum value, or it may also be the time point at which the variable describing the transverse dynamics first falls again below the upper limiting value, after having exceeded it.

From all the time points associated with the falling below the lower limiting value, a second time point is selected. Here as well, there are various possibilities.

The temporal interval between these two time points is then evaluated.

In this context, it should also be mentioned that the terms “first time point” and “second time point” are not intended to stipulate a temporal sequence of the two time points. Obviously, the temporal sequence may be first falling below the lower limiting value (second time point) and then exceeding the upper limiting value (first time point).

An advantage of the present invention is made especially clear if one assumes that the variable describing the transverse dynamics has a sinusoidal periodic curve. In this case, the essential measurements include:

1. whether the amplitude is large enough (i.e., whether a limiting value is exceeded or fallen below at all); and

2. whether the time interval between a maximum and a minimum of the sinusoidal curve is small enough.

This means that in order to detect the presence of a dangerous driving maneuver, it suffices to evaluate half of a period duration of the sinusoidal signal. This short time interval allows a rapid detection of the dangerous driving maneuver.

One exemplary embodiment provides: the time point associated with the exceeding is the time point at which the variable describing the transverse dynamics, after exceeding the upper limiting value, once again falls below it; and the time point associated with the falling below is the time point at which the variable describing the transverse dynamics falls below the lower limiting value.

Another exemplary embodiment is characterized in that the time point associated with the falling below is the time point at which the variable describing the transverse dynamics, after falling below the lower limiting value, once again exceeds it, and the time point associated with the exceeding is the time point at which the variable describing the transverse dynamics exceeds the upper limiting value.

This is immediately comprehensible for reasons of symmetry, because it means that an abrupt and powerful steering event to the right, followed by an equally abrupt and powerful countersteering (i.e., to the left), represents just as dangerous a driving maneuver as an abrupt and powerful steering event to the left, followed by an equally abrupt and powerful countersteering (this time to the right).

One exemplary embodiment is characterized in that the variable describing the transverse dynamics is a variable including at least a measured transverse acceleration, a measured steering angle, a measured yaw rate, a measured roll rate, a measured roll angle, measured distances to the ground or measured compression travel.

In this context, the measured quantities may be determined either using sensors or on the basis of mathematical models.

The variables yaw rate, steering angle, and transverse acceleration are already measured in a vehicle equipped with a driving dynamics control system. This means that in using output signals from these sensors, no significant additional expenditure is needed for implementing the method and the device according to the present invention.

One exemplary embodiment of the present invention is characterized in that the detection of a critical driving condition leads to influencing a driving dynamics control system. In this manner, the application range of driving dynamics control systems is expanded.

### BRIEF DESCRIPTION OF THE DRAWINGS

FIG. 1 is a flowchart of a sequence of an embodiment of a method for detecting dangerous driving maneuvers.

FIG. 2 is a graph for use in the detection of a dangerous driving maneuver on the basis of measured characteristic curves.

FIG. 3 is a flowchart of a sequence of another embodiment of a method for detecting dangerous driving maneuvers.

FIG. 4 is configuration of a device for detecting dangerous driving maneuvers.

### DETAILED DESCRIPTION

Simulations and driving tests show that driving maneuvers are particularly dangerous if accumulated roll energy is released from the suspension system. Roll energy is released especially in response to driving maneuvers such as sinusoidal steering or a doubled, sudden steering angle change, because, as a result of the curve change, the transverse acceleration and the roll angle change their mathematical signs. In this context, the term “sinusoidal steering” is understood to mean that the driver makes right-hand and left-hand curves in alternating rapid sequence (“slalom”). The term “doubled, sudden steering angle change” is understood to mean a steering event in one direction, followed by a reverse steering event. This corresponds to a lane change.

The danger of tipping is even greater when the natural roll frequency of the vehicle is excited. The latter is greatly dependent on the vehicle type and the load. An evaluation logic is proposed that, as an input signal, uses the signals or output quantities of a transverse acceleration sensor, of a transverse acceleration estimate from the wheel speed differential, of a steering angle sensor, of a yaw rate sensor, of a roll rate sensor, of a roll angle sensor, of distance sensors to the ground, or of compression travel sensors.

If the input signal exceeds a threshold value specifiable by parameters and if, within a defined time, the opposite, negative threshold value is fallen below, then a flag is set. The flag remains set until the input signal lies between the positive and negative thresholds for a defined time. The status of the flag (“low” or “high” or “0” or “1”) is, for example, routed to a driving dynamics regulator and, depending on the situation, can influence the following quantities:

1. the setpoint calculation (for example, the calculation of the transverse acceleration setpoint value);

2. regulator parameters (proportional component, integral component, differential component, control loop amplification);

3. filter constants for input and actuating signals;

4. intervention strategies (engine and/or braking interventions); and

5. Intervention threshold values of the driving dynamics regulator.

Besides routing it to a driving dynamics regulator, it is also possible for the status of the flag to be routed, for example, to an information system. The latter informs the driver about the existence of the dangerous driving situation.

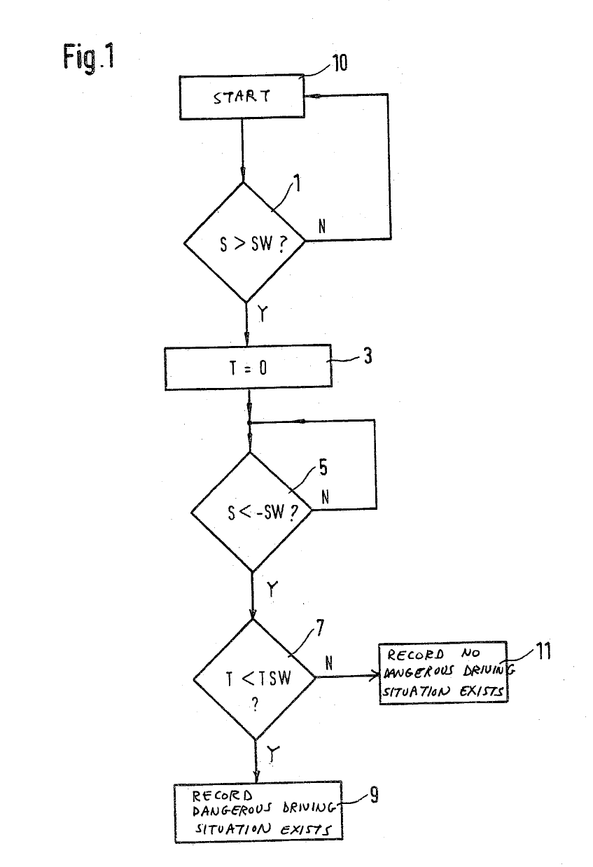

In FIG. 1, a method for detecting dangerous driving maneuvers is illustrated as a flow chart. In this context, the following abbreviations are used in FIG. 1:

S designates the variable describing the transverse dynamics,

SW and −SW designate the threshold values assigned to this variable,

T designates the length of a time interval, and

TSW designates the threshold value for the length of the time interval.

With Regard to the Sequence of FIG. 1:

Following the start in block 10, a query S>SW takes place in block 1. If S>SW (i.e., variable S describing the transverse dynamics exceeds positive threshold value SW), then, in block 3, a time counter is set at T=0. However, if S is not greater than SW, then the system branches back to the start in block 10, and the process begins anew. After T=0 is set in block 3, then, in block 5, the opposite query S<−SW is made. This means that the query is now made as to whether the variable describing the transverse dynamics also falls below a negative threshold value. If this is not the case, then the query in block 5 is once again made. However, if this is the case, i.e., S<−SW, then, in block 7, time interval TSW between the moment of exceeding the upper threshold value SW and that of falling below lower threshold value −SW, is checked. The query reads T<TSW. If T<TSW, then a dangerous driving situation exists and this is recorded in block 9. However, if T is greater than TSW, then it means that the moment of exceeding the upper threshold value and that of falling below the lower threshold value are sufficiently separated in time, and there is no dangerous driving situation. This is recorded in block 11. In the method illustrated in FIG. 1, the time interval between the moment of exceeding an upper limit (SW) and the subsequent moment of falling below a lower limit (−SW) was measured and evaluated. A dangerous driving situation is also at hand if the lower limit (−SW) is fallen below first and, shortly thereafter, the upper limit (SW) is exceeded. This method, the reverse of the former, was not illustrated in FIG. 1 for reasons of simplicity. For its realization, one merely needs to exchange blocks 1 and 5. Furthermore, lower limit −SW need not have exactly the same absolute value as upper limit +SW. It is entirely conceivable to work on the basis of an upper limit +SW1 and a lower limit −SW2.

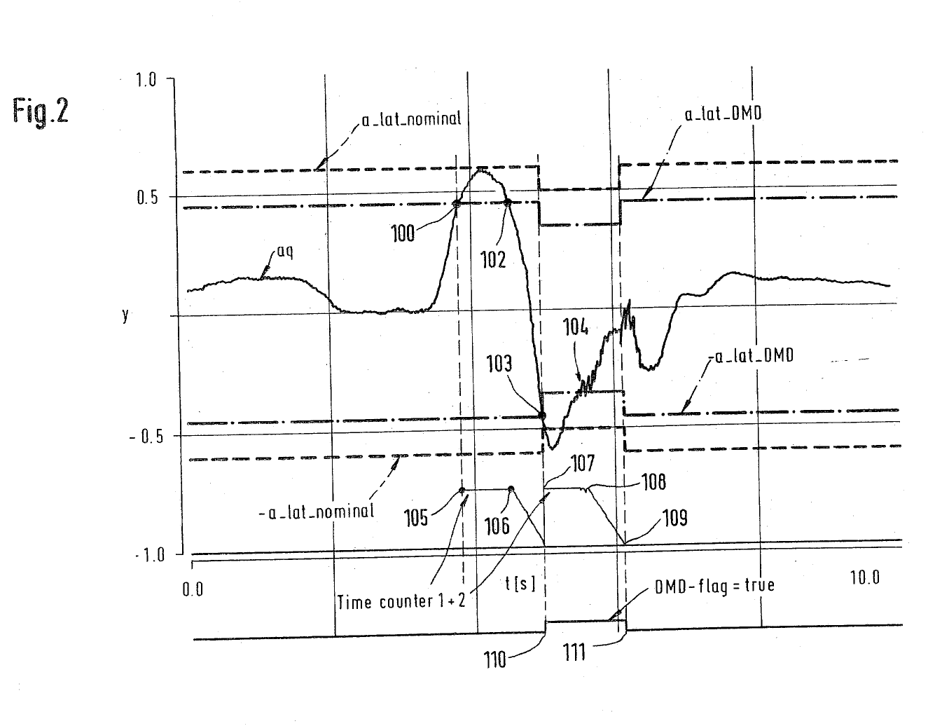

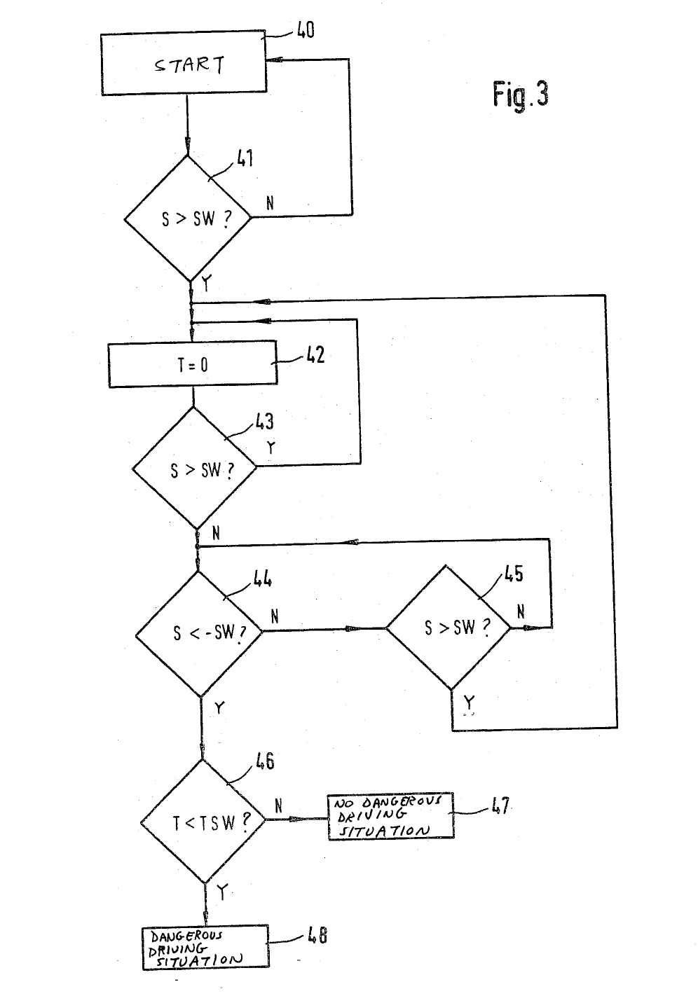

In FIG. 1, it should be taken into account that, for reasons of simplicity, only the basic embodiment of the method is illustrated. A somewhat more complex embodiment of the method and the corresponding flow chart, which takes into account several special cases that can arise, are illustrated in FIGS. 2 and 3 and discussed in detail below.

In FIG. 2, a detection of a dangerous driving maneuver is represented on the basis of measured signal curves. On the x-axis in FIG. 2, time t is plotted in seconds; on the y-axis, various quantities are plotted, each in a different scale. First, the differently illustrated curves are discussed:

1. Measured transverse acceleration aq is plotted as a solid line curve.

2. Transverse acceleration thresholds a_lat_nominal and −a_lat_nominal are plotted in dash-line form. These transverse acceleration thresholds are the intervention thresholds of a driving dynamics control system. That is, namely, exceeding a_lat_nominal or falling below lower limit −a_lat_nominal triggers a stabilization intervention of the driving dynamics control system.

3. Threshold values a_lat_DMD and −a_lat_DMD for detecting a dangerous driving maneuver are drawn as dot-dash lines.

4. In the lower part of the diagram, the values of time counters 1 and 2 (“time counter 1+2”) are indicated as well as, at the very bottom, the status of the DMD flag (“DMD flag=true”).

5. In addition, in FIG. 2, the important points 100, . . . , 111 are marked. These are essential in the following.

The sequence of the method is made clear in the simplest way on the basis of the following steps:

1. At point 100, measured transverse acceleration aq exceeds limit a₁₃ lat_DMD.

2. Therefore, a first time counter is placed in readiness immediately thereafter (point 105).

3. At point 102, aq once again falls below limit a_lat_DMD. The first time counter, placed in readiness, is now activated and begins to count. This may be seen at the bend at point 106. In this regard, it should also be noted that between the exceeding and the falling below a_lat_DMD, the value of aq has not reached intervention threshold a_lat_nominal of the driving dynamics control system. Therefore, no intervention of the driving dynamics control system occurs.

4. It is then checked as to whether, after the exceeding of the upper threshold value has ended (measured at point 102), the lower threshold value is fallen below. This is the case at point 103. There, Aq falls below lower threshold −a_lat_DMD.

5. As a consequence, the second time counter is placed in readiness(point 107). It is also established that the value of the first time counter has not yet entirely reached zero. This means that points 102 and 103 (106 and 107, respectively) are so closely adjusted in time that a dangerous driving maneuver is detected. This is expressed in the lowest curve by setting the flag (“DMD flag=true”) at point 110.

6. At point 104, the lower limit is once again exceeded. This leads to an activation of the second time counter (visible at the bend at point 108).

7. However, aq now no longer exceeds upper limiting value a_lat_nominal. The second time counter now reaches the value of zero (point 109), without the first time counter having once again to be placed in readiness. From this, it is concluded, now, there is no longer dangerous driving maneuver, and the flag can once again be reset (point 111).

In FIG. 2, it may also be seen that the amounts of threshold values a_lat_nominal, −a_lat_nominal, a_lat_DMD, and −a_lat_DMD are simultaneously reduced at point 103. This corresponds to the fact that point 103 marks the detection of a dangerous driving maneuver, and, therefore, the intervention thresholds are lowered. The fact that, in addition to thresholds a_lat_nominal (=the intervention thresholds of the driving dynamics regulator), thresholds a_lat_DMD were also modified, has to do with the fact, that in the present exemplary embodiment, the latter were coupled to each other in a simple manner. In a further exemplary embodiment, the threshold values may also be left unmodified. Following detection of the end of the dangerous driving maneuver at point 109, the threshold values are once again reset to the original values.

The sequence of the method described on the basis of FIG. 2 for detecting dangerous driving maneuvers is represented as a flow chart in FIG. 3. Following the start in block 40, query S>SW is made in block 41. In this context, S is once again the instantaneous measured value of the variable describing the transverse dynamics, and SW is the positive threshold value. If S>SW is not achieved, then the system branches back again to block 40. However, if S>SW is achieved, then, in block 42, a time counter is set to T=0. The latter then begins to count. Subsequently to block 42, a query S>SW is once again made in block 43. If S is still greater than SW, then the system branches back to block 42, and the time counter is reset again. The time counting begins again. However, if condition S>SW is not fulfilled, then, in block 44, query S<−SW is made. Here, two possibilities exist:

S is not less than −SW: it is then checked in block 45 whether S>SW. If this is not the case, then the system branches back to block 44. However, if S>SW, then the system branches back to block 42.

If S<−SW, it is then checked in block 46 whether T<TSW. If T<TSW, then the existence of a dangerous driving situation is established in block 48. If T is not less than TSW, then the absence of a dangerous driving situation is established in block 47.

The inverse case may also be checked, where limiting value −SW is first not met, and limiting value SW is subsequently exceeded. For reasons of simplicity, no attempt was made to depict this in FIG. 3.

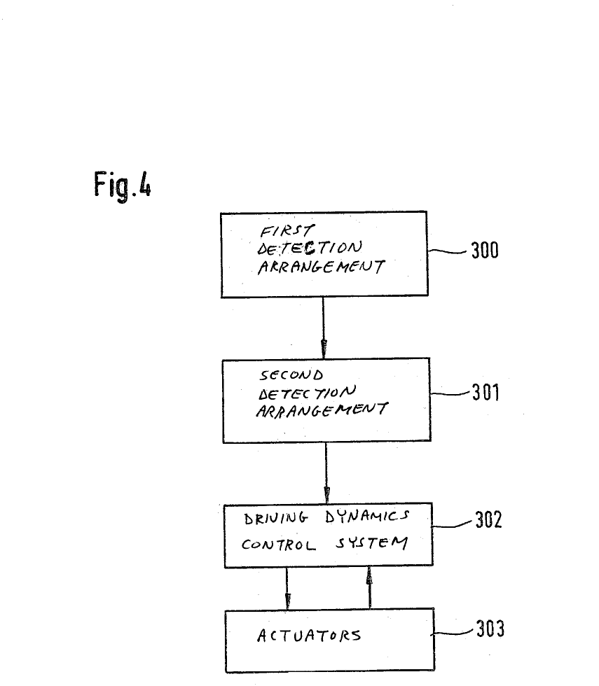

Finally, FIG. 4 illustrates a device for detecting dangerous driving maneuvers. Block 300 represents a first detection arrangement, in which the signals or quantities are made available that are necessary for detecting dangerous driving maneuvers. The first detection arrangement may be, for example, a transverse acceleration sensor. The output signal of block 300 is routed to block 301. In second detection arrangement 301, the quantities generated using the detection arrangement are compared with limiting values. In this way, it is established as to whether a dangerous driving maneuver is present or not. This information is transmitted to the driving dynamics control system 302. The driving dynamics control system interacts with actuators 303. These actuators 303 may be, for example, wheel brakes and/or an engine control.

What is claimed is:

1. A method for detecting a critical driving condition of a vehicle, comprising:
determining instantaneous values of a variable describing transverse dynamics at specific time points;
determining one of: (a) the variable exceeds an upper limiting value and, subsequently, the variable falls below a lower limiting value; and (b) the variable falls below the lower limiting value and, subsequently, the variable exceeds the upper limiting value; and
determining a time interval between a time point associated with the exceeding of the upper limiting value and a time point associated with the falling below of the lower limiting value does not meet a specified time threshold value.

2. The method according to claim 1, wherein the time point associated with the exceeding represents an instant that the variable describing the transverse dynamics, after exceeding the upper limiting value, once again reaches the upper limiting value immediately before falling below the upper limiting value, and the time point associated with the falling below represents an instant that the variable describing the transverse dynamics falls below the lower limiting value.

3. The method according to claim 1, wherein:
the time point associated with the exceeding is a time point at which the variable describing the transverse dynamics exceeds the upper limiting value; and
the time point associated with the falling below represents an instant that the variable describing the transverse dynamics, after falling below the lower limiting value, once again reaches the lower limiting value immediately before exceeding the lower limiting value.

4. The method according to claim 2, wherein the variable describing the transverse dynamics is a variable including at least one of a measured transverse acceleration, a measured steering angle, a measured yaw rate, a measured roll rate, a measured roll angle, a measured distance to the ground, and a measured compression travel.

5. The method according to claim 3, wherein the variable describing the transverse dynamics is a variable including at least one of a measured transverse acceleration, a measured steering angle, a measured yaw rate, a measured roll rate, a measured roll angle, a measured distance to the ground, and a measured compression travel.

6. The method according to claim 1, further comprising:
influencing a driving dynamics control system upon the detection of a critical driving condition.

7. A device for detecting a critical driving condition of a vehicle, comprising:
a first detection arrangement configured to detect instantaneous values of a variable describing transverse dynamics; and
a second detection arrangement, wherein the second detection arrangement determines one of: a) the variable exceeds an upper limiting value and then falls below a lower limiting value; and (b) the variable falls below the lower limiting value and then exceeds the upper limiting value; and wherein the second detection arrangement determines a time interval between a time point associated with the exceeding of the upper limiting value and a time point associated with the falling below the lower limiting value does not meet a specified time threshold value.
